(19) United States
(12) Patent Application Publication
(10) Pub. No.: US 2026/0340804 A1
(43) Pub. Date: Oct. 29, 2026

(54) METHOD AND APPARATUS FOR MEASURING CARGO

(71) Applicants: Hyundai Motor Company, Seoul (KR); Kia Corporation, Seoul (KR)

(72) Inventors: Se Do Oh, Hwaseong (KR); You Jin Shin, Hwaseong (KR); Minkooc Wee, Hwaseong (KR)

(21) Appl. No.: 19/395,547

(22) Filed: Nov. 20, 2025

(30) Foreign Application Priority Data
Apr. 25, 2025 (KR) 10-2025-0054334

(51) Int. Cl. G06T 7/00; G06T 7/33; G06T 17/20; G06V 10/46; G06V 10/74; G06V 10/776

(52) U.S. Cl. CPC G06T 7/0004; G06T 7/33; G06T 17/20; G06V 10/476; G06V 10/761; G06V 10/776; G06T 2207/10028; G06T 2207/30112

(57) ABSTRACT

A method for measuring cargo, performed by a computing device including a processor and a memory, may comprise connecting to a multi-sensor-based cargo measuring device comprising a plurality of 3D depth sensors, obtaining a plurality of raw point clouds corresponding to the cargo measured by the multi-sensor-based cargo measuring device, generating a single aligned point cloud by matching the plurality of raw point clouds to a single space, generating a refined point cloud by performing preprocessing on the aligned point cloud, constructing a K-dimensional tree (KD-Tree) space based on a mesh vertex, placing a ground-truth point cloud in a KD-Tree space, calculating of adjacent points and distances between the adjacent points and determining an uncertainty value, generating a heatmap mesh as a final model based on the uncertainty value, and performing a measurement with respect to the cargo by using the final model.

### CROSS-REFERENCE TO RELATED APPLICATION

This application claims, under 35 U.S.C. § 119(a), the benefit of Korean Patent Application No. 10-2025-0054334, filed Apr. 25, 2025, in the Korean Intellectual Property Office, the entire contents of which are incorporated herein by reference.

### BACKGROUND

### (a) Technical Field

The present disclosure relates to a method and apparatus for measuring cargo and, more particularly, relates to a method and apparatus for measuring cargo capable of indicating an uncertainty value with respect to a portion from which no point is collected in a mesh constructed from a point cloud generated by a large cargo measuring device and capable of measuring large cargo accurately and quickly.

### (b) Background

In the modern logistics and air transportation industries, when large cargo is delivered to a cargo terminal, it is essential to accurately measure the weight, volume, length, height, and shape of the cargo. Such information plays an important role in calculating the cost of transporting cargo and determining the loading sequence and position on the aircraft. However, there are several difficulties in accurately calculating the volume of large cargo.

Currently, workers use internal guidelines to stack, group, and package box-type loads. For regular cargo, the volume may be measured manually (e.g., by using a tape measure or other suitable means), but the measurement results may vary depending on the skill of the worker, and for irregular objects, volume measurement is more difficult. This type of manual method causes errors in calculating freight rates, and is particularly problematic for calculating freight rates for irregular cargo, as accurate volume measurement is difficult. The existing measuring device calculates the box volume by considering the outermost part of large cargo as a rectangular parallelepiped, which has the problem of high error rate in volume measurement for irregular cargo or skid-mounted cargo, resulting in overcharges.

In addition, there may be a deviation in time and packaging results as workers manually package cargo according to internal guidelines. This deviation requires repackaging during aircraft loading, which reduces overall work efficiency. In particular, it may be difficult to determine the loading sequence due to the irregular shapes of the cargo and the unique structure with a rounded roof of the cargo space, which results in suboptimal loading, creating empty spaces and leading to cost losses.

### SUMMARY

The present disclosure attempts to provide a method and apparatus for measuring cargo capable of indicating an uncertainty value with respect to a portion from which no point is collected in a mesh constructed from a point cloud generated by a large cargo measuring device and capable of measuring large cargo accurately and quickly.

A method for measuring cargo, performed by a computing device including a processor and a memory, may include connecting, by the processor, to a multi-sensor-based cargo measuring device provided with a plurality of 3D depth sensors, obtaining, by the processor, a plurality of raw point clouds corresponding to the cargo measured by the multi-sensor-based cargo measuring device, generating, by the processor, a single aligned point cloud by matching the plurality of raw point clouds to a single space, generating, by the processor, a refined point cloud by performing preprocessing on the aligned point cloud, constructing, by the processor, a K-dimensional tree (KD-Tree) space based on a mesh vertex, with respect to the mesh reconstructed from refined point cloud (a 3D mesh), placing, by the processor, a ground-truth point cloud in a KD-Tree space, calculating, by the processor, of adjacent points and distances between the adjacent points and determining an uncertainty value, generating, by the processor, a heatmap mesh as a final model based on the uncertainty value, and performing, by the processor, a measurement with respect to the cargo by using the final model.

The placing the ground-truth point cloud in the KD-Tree space may include allocating, by the processor, each point of the ground-truth point cloud to a space adjacent to a corresponding node based on a distance criterion to each node within the KD-Tree.

The calculating the uncertainty value may include searching, by the processor, for nearest points within a predetermined radius or in a predetermined number with respect to the mesh vertex by using the KD-Tree, and calculating a Euclidean distance between the mesh vertex and the adjacent point, and calculating, by the processor, the uncertainty value based on the calculated distance.

The generating the heatmap mesh as the final model may include generating, by the processor, a visualized 3D model by assigning color information according to the uncertainty value corresponding to each mesh vertex.

The performing the preprocessing may include applying, by the processor, a plurality of point cloud samplings to the aligned point cloud.

The plurality of point cloud samplings may include random sampling, voxel sampling, and uniform sampling.

The performing the preprocessing may include separating, by the processor, the cargo and a bottom surface supporting the cargo from the aligned point cloud, precisely separating, by the processor, a boundary between the cargo and the bottom surface, with respect to a lower portion of the cargo that is not easily distinguished from the bottom surface, and removing, by the processor, the bottom surface from the aligned point cloud to leave only the cargo.

The precisely separating may include setting, by the processor, a threshold value based on a distance between the cargo and the bottom surface, and additionally identifying, by the processor, a point corresponding to the bottom surface based on the threshold value.

The dividing the bottom surface may include extracting, by the processor, the bottom surface by a Random Sample Consensus (RANSAC) algorithm, and dividing the cargo based on the bottom surface.

The performing of the measurement with respect to the cargo may include calculating a water volume with respect to the cargo.

An apparatus for measuring cargo may include one or more non-transitory computer-readable media including an instruction, and one or more processors configured to perform an operation by executing the instruction, where the operation may include connecting to a multi-sensor-based cargo measuring device provided with a plurality of 3D depth sensors, obtaining a plurality of raw point clouds corresponding to the cargo measured by the multi-sensor-based cargo measuring device, generating a single aligned point cloud by matching the plurality of raw point clouds to a single space, generating a refined point cloud by performing preprocessing on the aligned point cloud, constructing a K-dimensional tree (KD-Tree) space based on a mesh vertex, with respect to the mesh reconstructed from refined point cloud (a 3D mesh), placing a ground-truth point cloud in a KD-Tree space, calculating adjacent points and distances between the adjacent points and determine an uncertainty value, generating a heatmap mesh as a final model based on the uncertainty value, and performing a measurement with respect to the cargo by using the final model.

The placing the ground-truth point cloud in the KD-Tree space may include allocating each point of the ground-truth point cloud to a space adjacent to a corresponding node based on a distance criterion to each node within the KD-Tree.

The calculating the uncertainty value may include searching for nearest points within a predetermined radius or in a predetermined number with respect to the mesh vertex by using the KD-Tree, and calculating a Euclidean distance between the mesh vertex and the adjacent point, and calculating the uncertainty value based on the calculated distance.

The generating the heatmap mesh as the final model may include generating a visualized 3D model by assigning color information according to the uncertainty value corresponding to each mesh vertex.

The performing the preprocessing may include applying a plurality of point cloud samplings to the aligned point cloud.

The plurality of point cloud samplings may include random sampling, voxel sampling, and uniform sampling.

The performing the preprocessing may include separating the cargo and a bottom surface supporting the cargo from the aligned point cloud, precisely separating a boundary between the cargo and the bottom surface, with respect to a lower portion of the cargo that is not easily distinguished from the bottom surface, and removing the bottom surface from the aligned point cloud to leave only the cargo.

The precisely separating may include setting a threshold value based on a distance between the cargo and the bottom surface, and additionally identifying a point corresponding to the bottom surface based on the threshold value.

The dividing the bottom surface may include extracting the bottom surface by a Random Sample Consensus (RANSAC) algorithm, and dividing the cargo based on the bottom surface.

One or more non-transitory computer-readable media may include an instruction executable by a computing device, where the instruction causes the computing device to perform an operation when executed by one or more processors of the computing device, and the operation may include connecting to a multi-sensor-based cargo measuring device provided with a plurality of 3D depth sensors, obtaining a plurality of raw point clouds corresponding to the cargo measured by the multi-sensor-based cargo measuring device, generating a single aligned point cloud by matching the plurality of raw point clouds to a single space, generating a refined point cloud by performing preprocessing on the aligned point cloud, constructing a K-dimensional tree (KD-Tree) space based on a mesh vertex, with respect to the mesh reconstructed from refined point cloud (a 3D mesh), placing a ground-truth point cloud in a KD-Tree space, calculating adjacent points and distances between the adjacent points and determine an uncertainty value, generating a heatmap mesh as a final model based on the uncertainty value, performing a measurement with respect to the cargo by using the final model.

According to an aspect of the present disclosure, a method for measuring cargo is provided. The method may comprise, using a computing device comprising a processor and a memory, obtaining a plurality of raw point clouds corresponding to a cargo measured by a multi-sensor-based cargo measuring device comprising a plurality of 3D depth sensors, generating a single aligned point cloud by matching the plurality of raw point clouds to a single space, generating a refined point cloud by performing preprocessing on the aligned point cloud, constructing a K-dimensional tree (KD-Tree) space based on a mesh vertex, placing a ground-truth point cloud in a KD-Tree space, calculating adjacent points and distances between the adjacent points and determining an uncertainty value, generating a heatmap mesh as a final model based on the uncertainty value, and performing a measurement with respect to the cargo by using the final model.

According to an exemplary embodiment, the method may comprise connecting, by the processor, to the multi-sensor-based cargo measuring device.

According to an exemplary embodiment, the placing the ground-truth point cloud in the KD-Tree space may comprise allocating each point of the ground-truth point cloud to a space adjacent to a corresponding node based on a distance criterion to each node within the KD-Tree.

According to an exemplary embodiment, the calculating the uncertainty value may comprise searching for nearest points within a predetermined radius or in a predetermined number with respect to the mesh vertex by using the KD-Tree, calculating a Euclidean distance between the mesh vertex and the adjacent point, and calculating, by the processor, the uncertainty value based on the calculated distance.

According to an exemplary embodiment, the generating the heatmap mesh as the final model may comprise generating a visualized 3D model by assigning color information according to the uncertainty value corresponding to each mesh vertex.

According to an exemplary embodiment, the performing the preprocessing may comprise applying a plurality of point cloud samplings to the aligned point cloud, and the plurality of point cloud samplings may comprise random sampling, voxel sampling, and uniform sampling.

According to an exemplary embodiment, the performing the preprocessing may comprise separating the cargo and a bottom surface supporting the cargo from the aligned point cloud, separating a boundary between the cargo and the bottom surface, and removing the bottom surface from the aligned point cloud to leave only the cargo.

According to an exemplary embodiment, the separating may comprise setting a threshold value based on a distance between the cargo and the bottom surface, and additionally identifying a point corresponding to the bottom surface based on the threshold value.

According to an exemplary embodiment, the dividing the bottom surface may comprise extracting the bottom surface by a Random Sample Consensus (RANSAC) algorithm, and dividing the cargo based on the bottom surface.

According to an exemplary embodiment, the performing the measurement with respect to the cargo may comprise calculating, by the processor, a water volume with respect to the cargo.

According to an aspect of the present disclosure, an apparatus for measuring cargo is provided. The apparatus may comprise one or more non-transitory computer-readable media comprising a processor and a memory. The memory may be configured to store instructions that, when executed by the processor, are configured to cause the processor to obtain a plurality of raw point clouds corresponding to a cargo measured by a multi-sensor-based cargo measuring device comprising a plurality of 3D depth sensors, generate a single aligned point cloud by matching the plurality of raw point clouds to a single space, generate a refined point cloud by performing preprocessing on the aligned point cloud, construct a K-dimensional tree (KD-Tree) space based on a mesh vertex, place a ground-truth point cloud in a KD-Tree space, calculate adjacent points and distances between the adjacent points and determine an uncertainty value, generate a heatmap mesh as a final model based on the uncertainty value, and perform a measurement with respect to the cargo by using the final model.

According to an exemplary embodiment, the placing the ground-truth point cloud in the KD-Tree space may comprise allocating each point of the ground-truth point cloud to a space adjacent to a corresponding node based on a distance criterion to each node within the KD-Tree.

According to an exemplary embodiment, the calculating the uncertainty value may comprise searching for nearest points within a predetermined radius or in a predetermined number with respect to the mesh vertex by using the KD-Tree, calculating a Euclidean distance between the mesh vertex and the adjacent point, and calculating the uncertainty value based on the calculated distance.

According to an exemplary embodiment, the generating the heatmap mesh as the final model may comprise generating a visualized 3D model by assigning color information according to the uncertainty value corresponding to each mesh vertex.

According to an exemplary embodiment, the performing the preprocessing may comprise applying a plurality of point cloud samplings to the aligned point cloud.

According to an exemplary embodiment, the plurality of point cloud samplings may comprise random sampling, voxel sampling, and uniform sampling.

According to an exemplary embodiment, the performing the preprocessing may comprises separating the cargo and a bottom surface supporting the cargo from the aligned point cloud, separating a boundary between the cargo and the bottom surface, and removing the bottom surface from the aligned point cloud to leave only the cargo.

According to an exemplary embodiment, the separating may comprises setting a threshold value based on a distance between the cargo and the bottom surface, and additionally identifying a point corresponding to the bottom surface based on the threshold value.

According to an exemplary embodiment, the dividing the bottom surface may comprise extracting the bottom surface by a Random Sample Consensus (RANSAC) algorithm, and dividing the cargo based on the bottom surface.

According to an aspect of the present disclosure, a non-transitory computer-readable media is provided. The non-transitory computer-readable media may comprise a memory configured to store instructions that, when executed by a processor, are configured to cause the processor to obtain a plurality of raw point clouds corresponding to a cargo measured by a multi-sensor-based cargo measuring device comprising a plurality of 3D depth sensors, generate a single aligned point cloud by matching the plurality of raw point clouds to a single space, generate a refined point cloud by performing preprocessing on the aligned point cloud, construct a K-dimensional tree (KD-Tree) space based on a mesh vertex, place a ground-truth point cloud in a KD-Tree space, calculate adjacent points and distances between the adjacent points and determine an uncertainty value, generate a heatmap mesh as a final model based on the uncertainty value, and perform a measurement with respect to the cargo by using the final model.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 illustrates a drawing for explaining an apparatus for measuring cargo, according to an exemplary embodiment of the present disclosure.

FIG. 2 illustrates a drawing for explaining a method for measuring cargo, according to an exemplary embodiment of the present disclosure.

FIG. 3 and FIG. 4 are drawings for explaining a method for measuring cargo. according to an exemplary embodiment of the present disclosure.

FIG. 5 illustrates a drawing for explaining a method for measuring cargo, according to an exemplary embodiment of the present disclosure.

FIG. 6 illustrates a drawing for explaining a computing device, according to an exemplary embodiment of the present disclosure.

It should be understood that the appended drawings are not necessarily to scale, presenting a somewhat simplified representation of various features illustrative of the basic principles of the present disclosure. The specific design features of the present disclosure, including, for example, specific dimensions, orientations, locations, and shapes, will be determined in part by the particular intended application and usage environment.

In the figures, the reference numerals refer to the same or equivalent portions of the present disclosure throughout the several figures of the drawing.

### DETAILED DESCRIPTION

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification and claims, when a part “includes” a certain element, it means that other elements may be further included, rather than excluding other elements, unless otherwise stated. Terms including ordinal numbers such as first, second, and the like will be used only to describe various constituent elements, and are not to be interpreted as limiting these constituent elements. The terms are only used to differentiate one constituent element from other constituent elements.

In addition, terms such as “. . . part,” “. . . portion,” “ . . . er/or,” or “module” disclosed in the present specification may mean a unit that may process at least one function or operation described in this specification, and this may be implemented by hardware, software, or a combination thereof. Additionally, at least some of the configurations or functions of the method and apparatus for measuring cargo according to the embodiments described below may be implemented as a program or software, and the program or software may be stored in a computer-readable medium.

In addition, the term “unit,” “control unit,” “control device,” or “controller” is merely a widely used term for naming an element or component that controls a specific function, and does not mean a generic functional unit. For example, each controller may include a communication device that communicates with another controller or a sensor to control a function assigned thereto, a computer-readable recording medium that stores an operating system (OS), logic commands, input/output information, and the like, and at least one processor that performs determination, calculation, computation, decision, and the like that are necessary for controlling a function assigned thereto.

Meanwhile, the processor may include a semiconductor integrated circuit and/or electronic devices that perform at least one or more of comparison, determination, computation, and decision to achieve programmed functions. The processor may be, for example, any one or a combination of a computer, a microprocessor, a central processing unit (CPU), an application-specific integrated circuit (ASIC), an electronic circuitry, and a logic circuitry.

In addition, the computer-readable recording medium (or simply a “memory”) may include all types of storage devices that store data readable by a computer system. The storage devices may include at least one type of, for example, flash memory, hard disk, micro-type memory, card-type (e.g., secure digital (SD) card or extreme digital (XD) card) memory, random-access memory (RAM), static RAM (SRAM), read-only memory (ROM), programmable ROM (PROM), electrically erasable PROM (EEPROM), magnetic RAM (MRAM), magnetic disk, or optical disc.

This recording medium may be electrically connected to the processor, and the processor may load and record data from the recording medium. The recording medium and the processor may be integrated or may be physically separated.

Hereinafter, various embodiments of the present disclosure are described in detail with reference to the attached drawings.

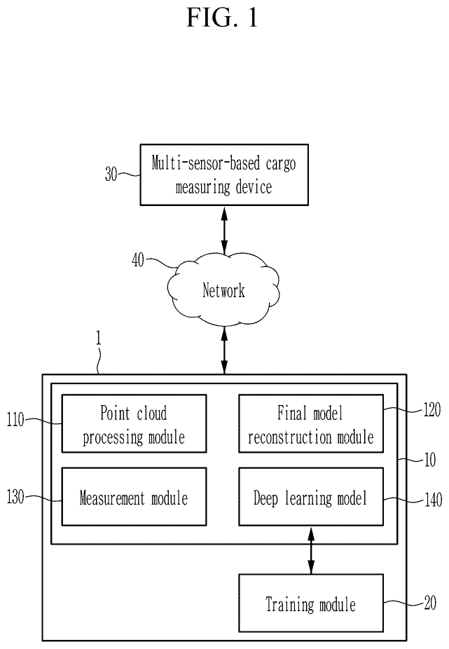

FIG. 1 illustrates a drawing for explaining an apparatus for measuring cargo, according to an exemplary embodiment of the present disclosure.

Referring to FIG. 1, a system 1 for measuring cargo, according to an exemplary embodiment, may comprise an apparatus 10 configured for measuring cargo, a training module 20, and a multi-sensor-based cargo measuring device 30. The apparatus 10 for measuring cargo and the multi-sensor-based cargo measuring device 30 may be configured to exchange data with each other through a network 40, and the training module 20 may be configured to train a deep learning model 140 used in the apparatus 10 for measuring cargo by using a preset training data.

In FIG. 1, the training module 20 is illustrated as an element implemented outside the apparatus 10 for measuring cargo, but, depending on specific implementation, purpose, or environment, the training module 20 may be implemented inside the apparatus 10 for measuring cargo, or, although not shown, may be implemented on a remote server. When implemented on a remote server, the apparatus 10 for measuring cargo may be provided with the deep learning model 140 for which training is completed, from a remote server through the network 40.

The multi-sensor-based cargo measuring device 30 may comprise a plurality of 3-dimensional (3D) depth sensors. The plurality of 3D depth sensors, each viewing the cargo from different angles, may be configured to be used to obtain a point cloud of the cargo. A plurality of raw point clouds may be obtained through the plurality of 3D depth sensors. On the other hand, the multi-sensor-based cargo measuring device 30 may further comprise a plurality of vision cameras. The plurality of vision cameras, each viewing the cargo from different angles, may be configured to be used to obtain an image of the cargo. A plurality of raw images may be obtained through the plurality of vision cameras. The multi-sensor-based cargo measuring device 30 may be configured to provide the plurality of raw point clouds and the plurality of raw images obtained in that way to the apparatus 10 for measuring cargo, through the network 40.

In some embodiments, the number of 3D depth sensors and the number of vision cameras, used in the multi-sensor-based cargo measuring device 30, may be set to be different from each other. In some embodiments, the number of vision cameras may be set to greater than the number of 3D depth sensors. For example, in the multi-sensor-based cargo measuring device 30, six vision cameras may be used, while four 3D depth sensors may be used.

The apparatus 10 for measuring cargo, according to an exemplary embodiment, may be implemented as a computing device comprising a processor and a memory. For example, the apparatus 10 for measuring cargo may be implemented as a computing device 50, such as that described later with reference to FIG. 8. In this case, the processor may correspond to a processor 510 of the computing device 50, and the memory may correspond to a memory 520 of the computing device 50.

Alternatively, in some embodiments, the apparatus 10 for measuring cargo may comprise one or more non-transitory computer-readable media including an instruction and one or more processors configured to perform an operation by executing the instruction. Here, the operation may comprise the configuration, function, step, or the like explained in this specification with respect to a method and apparatus for measuring cargo according to exemplary embodiments. In this specification, the term “module” is used in order to logically differentiate these operations performed by a model compression method and apparatus according to embodiments.

The apparatus 10 configured for measuring cargo may comprise a point cloud processing module 110, a final model reconstruction module 120, a measurement module 130, and the deep learning model 140.

The point cloud processing module 110 may be connected to the multi-sensor-based cargo measuring device 30, and may be configured to obtain the plurality of raw point clouds corresponding to the cargo measured by the multi-sensor-based cargo measuring device 30. For example, if the multi-sensor-based cargo measuring device 30 uses four 3D depth sensors, the point cloud processing module 110 may be configured to obtain four raw point clouds corresponding to each.

The point cloud processing module 110 may be configured to generate a single aligned point cloud by matching the raw point cloud to a single space. This is known as point cloud registration, and may involve aligning the plurality of raw point clouds to a common coordinate system to generate a single, consistent data set. In some embodiments, the point cloud processing module 110 may be configured to precisely align point clouds by first performing rough alignment by extracting feature points from the raw point cloud and finding corresponding points, and then repeatedly matching the nearest neighbors between points in each point cloud and minimizing the distance between the matched points. Additionally, a transformation matrix including rotation, translation, and scaling may be applied to each point cloud. When the plurality of raw point clouds are merged into a single common coordinate system, they may share the same reference frame, and during this process, the relative position and direction of each cloud may be adjusted.

The point cloud processing module 110 may be configured to perform preprocessing on the aligned point cloud, to generate a refined point cloud.

In some embodiments, the point cloud processing module 110 may be configured to apply a plurality of point cloud samplings to the aligned point cloud. Here, the point cloud sampling may refer to selecting some points from a point cloud to adjust the density of data or improve processing efficiency. The point cloud processing module 110 may be configured to use two or more point cloud sampling techniques rather than just one point cloud sampling technique.

In some embodiments, the point cloud sampling may comprise random sampling, voxel sampling, and uniform sampling. For example, the point cloud processing module 110 may be configured to perform point cloud sampling by using random sampling and voxel sampling, and the user may appropriately adjust the usage proportion of each of random sampling and voxel sampling through predetermined parameters. By adopting the above-described method, more points may be selected in regions where more points are collected, and fewer points may be selected in regions where fewer points are collected.

On the other hand, in some embodiments, the point cloud processing module 110 may be configured to separate the cargo and a bottom surface supporting the cargo from the aligned point cloud, and may be configured to precisely separate a boundary between the cargo and the bottom surface, with respect to a lower portion of the cargo that is not easily distinguished from the bottom surface. Subsequently, the point cloud processing module 110 may be configured to perform a task of removing the bottom surface from the aligned point cloud and leaving only the cargo.

In general, the point cloud data may comprise both cargo and the bottom surface, so a process of distinguishing the two elements may be required. In particular, when the lower portion of the cargo is close to the bottom surface and the boundary is unclear, the point cloud processing module 110 may be configured to accurately identify the shape and position of the cargo by precisely separating the boundary between the cargo and the bottom surface. The point cloud processing module 110 may be configured to apply an algorithm that separates the cargo and the bottom surface, to perform the task of effectively detecting the bottom surface, and remove the bottom surface portion from the aligned point cloud, thereby leaving only the cargo. The above-described process may comprise a data refining step for volume measurement or shape analysis of the cargo, ultimately enabling accurate measurement and analysis. The bottom surface removal work may correspond to an important feature that reduces the complexity of point cloud data and allowing subsequent processing to focus solely on the cargo.

In some embodiments, the point cloud processing module 110 may be configured to set a threshold value based on a distance between the cargo and the bottom surface, and may perform precise separation, by additionally identifying a point corresponding to the bottom surface based on the threshold value. For example, the point cloud processing module 110 may be configured to analyze a position of each point, determine that a point within the threshold value range belongs to the bottom surface, and classify that point as the bottom surface. In this way, the points belonging to the bottom surface may be accurately identified even in the lower region of the cargo where the boundary with respect to the bottom surface is vague, enabling precise separation between the cargo and the bottom surface.

In some embodiments, in order to divide the bottom surface, the point cloud processing module 110 may be configured to extract the bottom surface by a Random Sample Consensus (RANSAC) algorithm, and may be configured to divide the cargo based on the bottom surface. By adopting the RANSAC algorithm, a random point may be selected from the point cloud, to generate a plane model corresponding to the bottom surface, the points that fits well to the plane model may be identified as inliers to extract only the points constituting the bottom surface, and other points may be classified as the outliers and separated into cargo.

The final model reconstruction module 120 may be configured to reconstruct the final model, by inputting the refined point cloud into the deep learning model 140, and having the deep learning model 140 predict a 3D mesh. Specifically, the final model reconstruction module 120 may be configured to construct a K-dimensional tree (KD-Tree) space based on a mesh vertex of the 3D mesh. The mesh vertices have coordinates in three-dimensional space, and may be important elements that define the overall shape and structure of the mesh. The KD-Tree is a data structure for efficiently managing and searching the mesh vertices, and may partition the mesh vertices according to specific rules and store them in a tree form.

In addition, the final model reconstruction module 120 may be configured to place a colored point cloud in the KD-Tree space. The colored point cloud has RGB color information for each point, and may provide data for coloring the 3D mesh. Each point of the colored point cloud may be mapped to the mesh vertex in the KD-Tree, and through this, may allow colors corresponding to each region of the mesh to be assigned.

In addition, the final model reconstruction module 120 may be configured to calculate adjacent points and distances between the adjacent points. The adjacent point may be efficiently searched by using the structure of the KD-Tree, and the color and uncertainty value of the mesh vertex may be estimated based on the calculated distance information. Through this process, the visual consistency of the mesh may be increased, and a final 3D model with color information may be completed.

In some embodiments, the final model reconstruction module 120 may be configured to perform color matching by collecting colors of points adjacent to the mesh vertex, and may be configured to reconstruct a colored mesh into the final model.

In some embodiments, the final model reconstruction module 120 may be configured to generate a heatmap mesh based on the distance between the adjacent points, and may reconstruct the heatmap mesh into the final model.

In more detail, the final model reconstruction module 120 may be configured to construct the KD-Tree space based on the mesh vertex, with respect to the mesh reconstructed from refined point cloud, and may place a ground-truth point cloud in the KD-Tree space. In addition, the final model reconstruction module 120 may be configured to generate the heatmap mesh as the final model based on the uncertainty value, by calculating the adjacent points and the distances between the adjacent points and determining the uncertainty value.

For example, specifically, the final model reconstruction module 120 may be configured to construct the KD-Tree space based on coordinates of each mesh vertex, with respect to the mesh reconstructed from the refined point cloud, and may search for the adjacent point corresponding to each mesh vertex by placing the ground-truth point cloud within the corresponding KD-Tree space. In addition, the final model reconstruction module 120 may be configured to calculate a Euclidean distance between each mesh vertex and the adjacent point from the searched adjacent points, and may calculate the uncertainty value of each mesh vertex based on the average value or statistical characteristics of the corresponding distances. The calculated uncertainty value may correspond to each mesh vertex, and the final model reconstruction module 120 may be configured to generate the heatmap mesh that can be visualized, based on the uncertainty value, and output it as the final model.

In some embodiments, the final model reconstruction module 120 may be configured to allocate each point of the ground-truth point cloud to a space adjacent to a corresponding node based on a distance criterion to each node within the KD-Tree, in order to place the ground-truth point cloud in the KD-Tree space. Accordingly, actually measured points around each mesh vertex may be efficiently connected, and data matching accuracy for subsequent distance-based analysis may be improved.

In some embodiments, in order to calculate the uncertainty value, the final model reconstruction module 120 may be configured to search for nearest points within a predetermined radius or in a predetermined number with respect to the mesh vertex by using the KD-Tree, may be configured to calculate the Euclidean distance between the mesh vertex and the adjacent point, and may be configured to calculate the uncertainty value based on the calculated distance. Through this, how far each mesh vertex is away from the actually measured point may be quantitatively identified, and regions with missing measurements or regions with low mesh reliability may be effectively distinguished.

In some embodiments, in order to generate the heatmap mesh as the final model, the final model reconstruction module 120 may be configured to generate a visualized 3D model by assigning color information according to the uncertainty value corresponding to each mesh vertex. Accordingly, the user may intuitively identify the uncertain region.

The measurement module 130 may be configured to perform measurement on the cargo by using the final model. The measurement module 130 may be configured to calculate, for example, a water volume with respect to the cargo. The water volume relates to a process of measuring an entire volume occupied by the cargo, and may mean the volume of water occupied by the cargo when the cargo is submerged in a certain water tank. The measurement module 130 may be configured to calculate the water volume by mathematically integrating the interior space of the cargo by using the 3D mesh model, or by estimating the volume based on outer lines and surfaces of the cargo. This function enables accurate volume measurement even when the size or shape of the cargo is irregular, and may provide useful data for calculating the cost of transporting cargo or for establishing loading plans.

According to an exemplary embodiment of the present disclosure, the accuracy of cargo measurement may be improved by obtaining the point cloud with respect to the cargo from the multi-sensor-based cargo measuring device and performing preprocessing on point cloud. In addition, by inputting the point cloud with preprocessing applied into a deep learning model to generate the 3D mesh with respect to the cargo, and performing measurement on it, it is possible to implement automated measurement with respect to large cargo, and perform fast and accurate measurement for large cargo.

In addition, considering the characteristic of automatically reconstructing the mesh even with respect to a region where no point is collected due to blind spots of the 3D scanner or the like, an uncertainty index that can quantify such an uncertain region may be calculated and displayed. Specifically, taking the reconstructed 3D mesh and the actually measured point cloud as the ground truth, distances between the mesh vertex and the adjacent points may be calculated based on the KD-Tree, so that the uncertainty of each mesh vertex may be quantified. Through this, the accuracy of mesh surface, which is difficult to identify simply by the overall volume error, may be verified at the individual point level, and the region that has not been measured may be recognized through the uncertainty heatmap. Furthermore, this uncertainty information can be used to the maintenance of large cargo objects or to improve visualization, such as by making uncertain areas transparent or highlighting them.

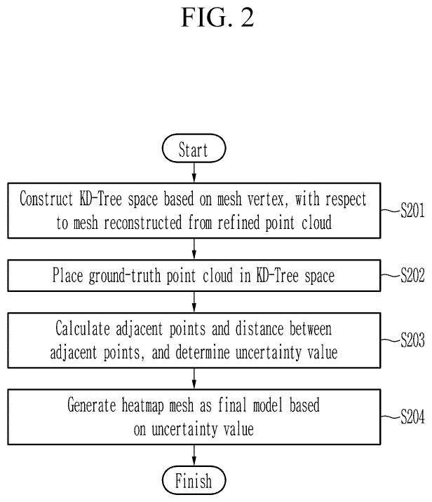

FIG. 2 illustrates a drawing for explaining a method for measuring cargo, according to an exemplary embodiment of the present disclosure.

Referring to FIG. 2, a method for measuring cargo according to an embodiment may comprise a step S201 of constructing the KD-Tree space based on the mesh vertex, with respect to the mesh reconstructed from refined point cloud, a step S202 of placing the ground-truth point cloud in the KD-Tree space, a step S203 of calculating the adjacent points and the distances between the adjacent points and determining the uncertainty value, and a step S204 of generating the heatmap mesh as the final model based on the uncertainty value.

For more detailed information about the above method, reference can be made to the description of the embodiments described in this specification, so a redundant description is not included herein.

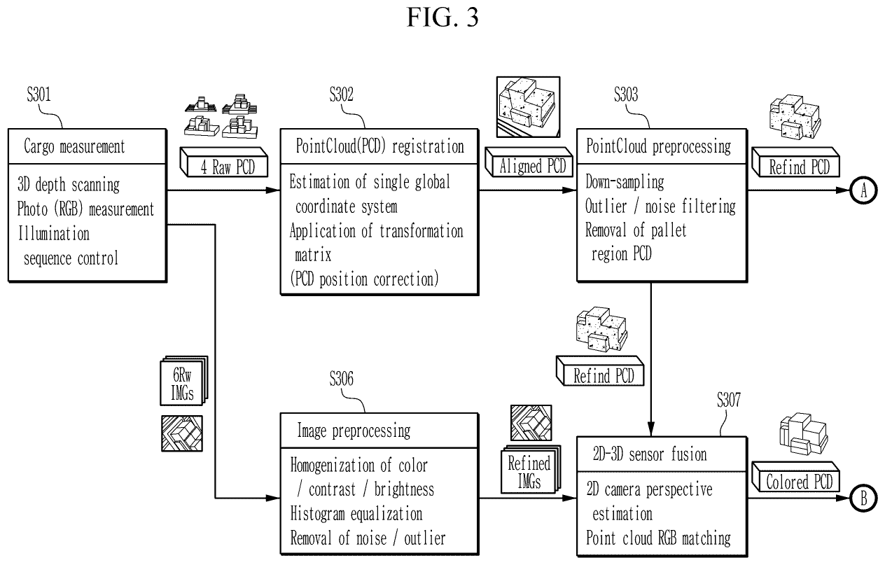

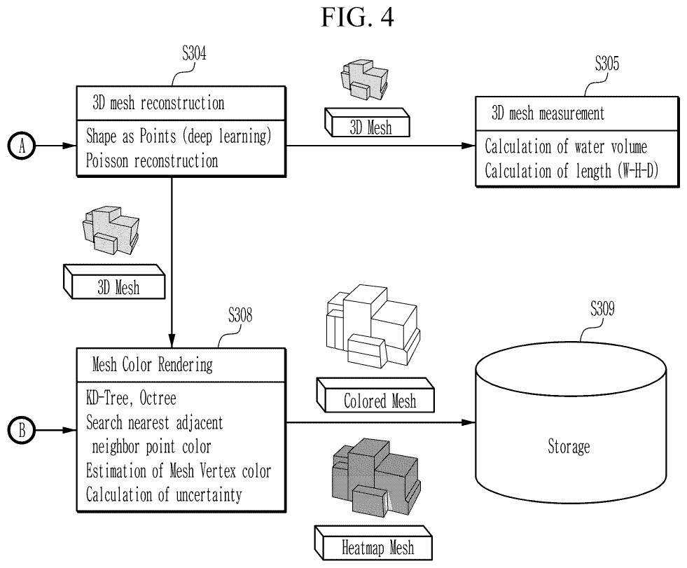

FIG. 3 and FIG. 4 are drawings for explaining a method for measuring cargo, according to an exemplary embodiment of the present disclosure.

Referring to FIG. 3 and FIG. 4, a method for measuring cargo, according to an exemplary embodiment, may comprise performing a cargo measurement, at step S301. In this step, 3D depth scanning and RGB photographing may be performed in order to measure a 3D shape of the cargo. By controlling the illumination sequence, the measurement environment may be optimized, and high-quality data may be collected. Four raw point clouds and six raw images may be output as results.

At step S302, a point cloud registration step may be performed. This step may be performed by receiving the output of the cargo measurement step S301 as input. The four raw point clouds may be aligned to a single global coordinate system, and a position of each point cloud may be corrected by applying a transformation matrix. Finally, the aligned point cloud may be generated.

At step S303, a point cloud preprocessing step may be performed. This step may use the results of the point cloud registration step S302 as input. The size of data may be reduced through down-sampling, and the quality of data may be improved by filtering out outliers and noise. In addition, the refined point cloud may be output by removing the point cloud of the pallet region.

At step S304, a 3D mesh reconstruction step may be performed. In this step, the refined point cloud of the point cloud preprocessing step S303 may be received as input, and the 3D mesh may be generated. A precise 3D mesh may be constructed by utilizing deep learning-based “Shape as Points” and Poisson reconstruction technique. The 3D mesh may be output as results.

At step S305, a 3D mesh measurement step may be performed. In this step, the measurement work may be performed by using the 3D mesh generated in the 3D mesh reconstruction step S304. By calculating the water volume, and measuring the height, width, and depth (W-H-D) of mesh, the volume and shape of the cargo may be accurately analyzed.

At step S306, an image preprocessing step may be performed. This step may use the six raw images collected in the cargo measurement step S301 as input. The image quality may be improved by homogenizing the color, contrast, and brightness, and by performing histogram equalization and noise removal. As a result, a refined image may be generated.

At step S307, a 2D-3D sensor fusion step may be performed. This step may be performed by using the output of the point cloud preprocessing step S303 and the image preprocessing step S306. The colored point cloud may be generated performing perspective estimation of the 2D camera, and matching the point cloud with an RGB image.

At step S308, a mesh color rendering step may be performed. In this step, the 3D mesh generated in the 3D mesh reconstruction step S304 and the colored point cloud of the 2D-3D sensor fusion step S307 may be used as input. In this process, a color of a neighbor point nearest adjacent to each vertex of the mesh may be searched by utilizing the KD-Tree and octree, and the colors of the mesh vertices may be estimated based on this. In addition, the reliability of the mesh may be evaluated by calculating the uncertainty value with respect to the color estimation. As a result, the colored mesh and the heatmap mesh may be generated, so that 3D visualization of the cargo can be strengthened.

At step S309, a step of storing the generated mesh may be performed. In the last step, the colored mesh and the heatmap mesh generated in the mesh color rendering step S308 may be stored. These may be stored in a database or file system, for later analysis or reference.

In accordance with the above process flow, the accuracy of cargo measurement may be improved by obtaining the point cloud with respect to the cargo from the multi-sensor-based cargo measuring device and performing preprocessing on point cloud. In addition, by inputting the point cloud with preprocessing applied into a deep learning model to generate the 3D mesh with respect to the cargo, and performing measurement on it, it is possible to implement automated measurement with respect to large cargo, and perform fast and accurate measurement for large cargo.

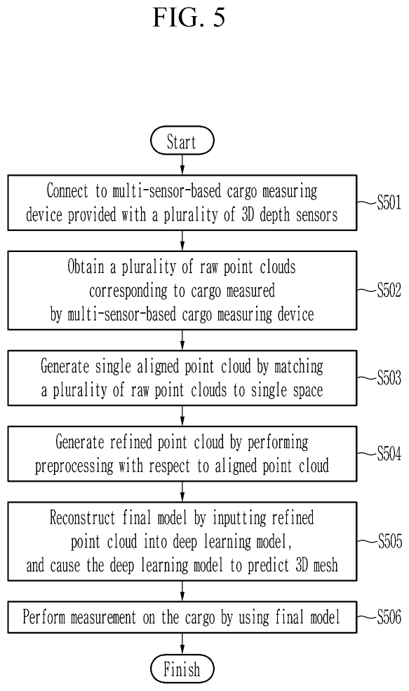

FIG. 5 illustrates a drawing for explaining a method for measuring cargo, according to an exemplary embodiment of the present disclosure.

Referring to FIG. 5, a method for measuring cargo according to an embodiment may comprise a step S501 of connecting to the multi-sensor-based cargo measuring device provided with the plurality of 3D depth sensors, a step S502 of obtaining the plurality of raw point clouds corresponding to the cargo measured by the multi-sensor-based cargo measuring device, a step S503 of generating the single aligned point cloud by matching the plurality of raw point clouds to a single space, a step S504 of generating the refined point cloud by performing preprocessing on the aligned point cloud, a step S505 of reconstructing the final model by inputting the refined point cloud into a deep learning model, and causing the deep learning model to predict the 3D mesh, and a step S506 of performing measurement on the cargo by using the final model.

For more detailed information about the above method, reference can be made to the description of the embodiments described in this specification, so a redundant description is not included herein.

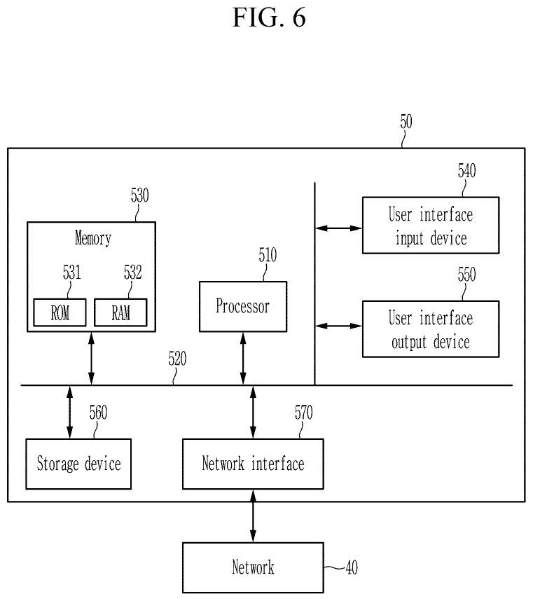

FIG. 6 illustrates a drawing for explaining a computing device, according to an exemplary embodiment.

Referring to FIG. 6, a method and apparatus for measuring cargo, according to embodiments, may be implemented by using the computing device 50. The computing device 50 may be configured to be implemented as various forms of electronic devices, servers, or similar devices, and its function may be implemented through a combination of software and hardware.

The computing device 50 may comprise at least one of a processor 510, a memory 530, a user interface input device 540, a user interface output device 550, and a storage device 560 that communicate through a bus 520. The computing device 50 may also comprise a network interface 570 electrically connected to the network 40. The network interface 570 may be configured to transmit or receive signals with other entities through the network 40.

The processor 510 may be implemented as various types of computing devices, for example, a micro controller unit (MCU), an application processor (AP), a central processing unit (CPU), a graphics processing unit (GPU), a neural processing unit (NPU), quantum processing unit (QPU), or the like. The processor 510 may comprise a semiconductor device that executes instructions stored in the memory 530 or the storage device 560, and may play a core role of the system. The program code and data stored in the memory 530 or the storage device 560 may be configured to command the processor 510 to perform a specific work, thereby enabling the overall operation of the system. The processor 510 may be configured to implement various functions and methods described above with reference to FIG. 1 to FIG. 5.

The memory 530 and the storage device 560 may comprise various types of volatile or non-volatile storage media for storing and accessing data of the system. For example, the memory 530 may comprise a read-only memory (ROM) 531 and a random-access memory (RAM) 532. In some embodiments, the memory 530 may be built into the processor 510, in which case, the data transmission speed between the memory 530 and the processor 510 may be very fast. In some other embodiments, the memory 530 may be located outside the processor 510, in which case, the memory 530 may be connected to the processor 510 through various data buses or interfaces. This connection may be made through already known various means, for example, a Peripheral Component Interconnect Express (PCIe) interface for high-rate data transmission or a memory controller.

In some embodiments, at least some of components or functions of a method and apparatus for measuring cargo, according to embodiments, may be implemented as a program or software executed by the computing device 50, and the program or software may be stored in computer-readable recording medium or storage medium. Specifically, a computer-readable recording medium or storage medium, according to an exemplary embodiment, may be configured to record a program for executing steps included in an implementation of the method and apparatus for measuring cargo according to embodiments, on a computer including the processor 510 executing a program or instructions stored in the memory 530 or the storage device 560.

In some embodiments, at least some of components or functions of a method and apparatus for measuring cargo, according to embodiments, may be implemented by using hardware or circuitry of the computing device 50, or may implemented as separate hardware or circuitry that may be electrically connected to the computing device 50.

In some embodiments, one or more non-transitory computer-readable media including an instruction executable by a computing device 50 may be provided, where the instruction may cause the computing device 50 to perform the operation when executed by one or more processors of the computing device 50. Here, the operation may include components, functions, steps, or the like, described in this specification with respect to a method and apparatus for measuring cargo according to embodiments.

According to an embodiment, the accuracy of cargo measurement may be improved by obtaining the point cloud with respect to the cargo from the multi-sensor-based cargo measuring device and performing preprocessing on point cloud. In addition, by inputting the point cloud with preprocessing applied into a deep learning model to generate the 3D mesh with respect to the cargo, and performing measurement on it, it is possible to implement automated measurement with respect to large cargo, and perform fast and accurate measurement for large cargo.

In addition, considering the characteristic of automatically reconstructing the mesh even with respect to a region where no point is collected due to blind spots of the 3D scanner or the like, an uncertainty index that can quantify such an uncertain region may be calculated and displayed. Specifically, taking the reconstructed 3D mesh and the actually measured point cloud as the ground truth, distances between the mesh vertex and the adjacent points may be calculated based on the KD-Tree, so that the uncertainty of each mesh vertex may be quantified. Through this, the accuracy of mesh surface, which is difficult to identify simply by the overall volume error, may be verified at the individual point level, and the region that has not been measured may be recognized through the uncertainty heatmap. Furthermore, this uncertainty information can be used to the maintenance of large cargo objects or to improve visualization, such as by making uncertain areas transparent or highlighting them.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

What is claimed is:

1. A method for measuring cargo, comprising:
using a computing device comprising a processor and a memory:
obtaining a plurality of raw point clouds corresponding to a cargo measured by a cargo measuring device,
wherein the cargo measuring device comprises a plurality of 3D depth sensors;
generating a single aligned point cloud by matching the plurality of raw point clouds to a single space;
generating a refined point cloud by performing preprocessing on the aligned point cloud;
constructing a K-dimensional tree (KD-Tree) space based on a mesh vertex;
placing a ground-truth point cloud in a KD-Tree space;
calculating adjacent points and distances between the adjacent points and determining an uncertainty value;
generating a heatmap mesh as a final model based on the uncertainty value; and
performing a measurement with respect to the cargo by using the final model.

2. The method of claim 1, further comprising connecting, by the processor, to the cargo measuring device,
wherein the cargo measuring device comprises a multi-sensor-based cargo measuring device.

3. The method of claim 1, wherein the placing the ground-truth point cloud in the KD-Tree space comprises allocating each point of the ground-truth point cloud to a space adjacent to a corresponding node based on a distance criterion to each node within the KD-Tree.

4. The method of claim 1, wherein the calculating the uncertainty value comprises:
searching for nearest points within a predetermined radius or in a predetermined number with respect to the mesh vertex by using the KD-Tree;
calculating a Euclidean distance between the mesh vertex and the adjacent point; and
calculating, by the processor, the uncertainty value based on the calculated distance.

5. The method of claim 1, wherein the generating the heatmap mesh as the final model comprises generating a visualized 3D model by assigning color information according to the uncertainty value corresponding to each mesh vertex.

6. The method of claim 1, wherein:
the performing the preprocessing comprises applying a plurality of point cloud samplings to the aligned point cloud, and
the plurality of point cloud samplings comprises random sampling, voxel sampling, and uniform sampling.

7. The method of claim 1, wherein the performing the preprocessing comprises:
separating the cargo and a bottom surface supporting the cargo from the aligned point cloud;
separating a boundary between the cargo and the bottom surface; and
removing the bottom surface from the aligned point cloud to leave only the cargo.

8. The method of claim 7, wherein the separating comprises:
setting a threshold value based on a distance between the cargo and the bottom surface;
and additionally identifying a point corresponding to the bottom surface based on the threshold value.

9. The method of claim 7, wherein the dividing the bottom surface comprises:
extracting the bottom surface by a Random Sample Consensus (RANSAC) algorithm; and
dividing the cargo based on the bottom surface.

10. The method of claim 1, wherein the performing the measurement with respect to the cargo comprises calculating, by the processor, a water volume with respect to the cargo.

11. An apparatus for measuring cargo, comprising:
one or more non-transitory computer-readable media comprising a processor and a memory, wherein the memory is configured to store instructions that, when executed by the processor, are configured to cause the processor to:
obtain a plurality of raw point clouds corresponding to a cargo measured by a cargo measuring device,
wherein the cargo measuring device comprises a plurality of 3D depth sensors;
generate a single aligned point cloud by matching the plurality of raw point clouds to a single space;
generate a refined point cloud by performing preprocessing on the aligned point cloud;
construct a K-dimensional tree (KD-Tree) space based on a mesh vertex;
place a ground-truth point cloud in a KD-Tree space;
calculate adjacent points and distances between the adjacent points and determine an uncertainty value;
generate a heatmap mesh as a final model based on the uncertainty value; and
perform a measurement with respect to the cargo by using the final model.

12. The apparatus of claim 11, wherein the placing the ground-truth point cloud in the KD-Tree space comprises allocating each point of the ground-truth point cloud to a space adjacent to a corresponding node based on a distance criterion to each node within the KD-Tree.

13. The apparatus of claim 11, wherein the calculating the uncertainty value comprises:
searching for nearest points within a predetermined radius or in a predetermined number with respect to the mesh vertex by using the KD-Tree;
calculating a Euclidean distance between the mesh vertex and the adjacent point; and
calculating the uncertainty value based on the calculated distance.

14. The apparatus of claim 11, wherein the generating the heatmap mesh as the final model comprises generating a visualized 3D model by assigning color information according to the uncertainty value corresponding to each mesh vertex.

15. The apparatus of claim 11, wherein the performing the preprocessing comprises applying a plurality of point cloud samplings to the aligned point cloud.

16. The apparatus of claim 15, wherein the plurality of point cloud samplings comprises random sampling, voxel sampling, and uniform sampling.

17. The apparatus of claim 11, wherein the performing the preprocessing comprises:
separating the cargo and a bottom surface supporting the cargo from the aligned point cloud;
separating a boundary between the cargo and the bottom surface; and
removing the bottom surface from the aligned point cloud to leave only the cargo.

18. The apparatus of claim 17, wherein the separating comprises:
setting a threshold value based on a distance between the cargo and the bottom surface; and
additionally identifying a point corresponding to the bottom surface based on the threshold value.

19. The apparatus of claim 17, wherein the dividing the bottom surface comprises:
extracting the bottom surface by a Random Sample Consensus (RANSAC) algorithm; and
dividing the cargo based on the bottom surface.

20. A non-transitory computer-readable media, comprising:
a memory configured to store instructions that, when executed by a processor, are configured to cause the processor to:
obtain a plurality of raw point clouds corresponding to a cargo measured by a cargo measuring device,
wherein the cargo measuring device comprises a plurality of 3D depth sensors;
generate a single aligned point cloud by matching the plurality of raw point clouds to a single space;
generate a refined point cloud by performing preprocessing on the aligned point cloud;
construct a K-dimensional tree (KD-Tree) space based on a mesh vertex;
place a ground-truth point cloud in a KD-Tree space;
calculate adjacent points and distances between the adjacent points and determine an uncertainty value;
generate a heatmap mesh as a final model based on the uncertainty value; and
perform a measurement with respect to the cargo by using the final model.
